(19) United States
(12) Patent Application Publication
(10) Pub. No.: US 2002/0020113 A1
(43) Pub. Date: Feb. 21, 2002

(54) Superadiabatic generation of hydrogen and hydrocarbons

(75) Inventors: Lawrence A. Kennedy, Naperville, IL (US); Alexander A. Fridman, Naperville, IL (US); Alexei A. Saveliev, Naperville, IL (US); Marcus Drayton, Oak Park, IL (US)

Correspondence Address: MARSHALL, O'TOOLE, GERSTEIN, MURRAY & BORUN, 6300 SEARS TOWER, 233 SOUTH WACKER DRIVE, CHICAGO, IL, 60606-6402, US

(73) Assignee: The Board of Trustees of the University of

(21) Appl. No.: 09/800,987

(22) Filed: Mar. 7, 2001

Related U.S. Application Data
(63) Continuation-in-part of application No. 09/201,511, filed on Nov. 30, 1998, now abandoned.
(60) Provisional application No. 60/067,201, filed on Dec. 1, 1997.

(51) Int. Cl. C01B 3/38; C01B 3/36

(52) U.S. Cl. 48/198.7; 48/197 R

(57) ABSTRACT

A method of generating hydrogen and hydrocarbons utilizing superadiabatic combustion is disclosed.

### CROSS REFERENCE TO RELATED APPLICATION

This is a continuation-in-part of co-pending U.S. patent application Ser. No. 09/201,511 filed Nov. 30, 1998, which claims the benefit of U.S. provisional patent application Ser. No. 60/067,201 filed Dec. 1, 1997, the disclosures of which are hereby incorporated herein by reference.

### BACKGROUND OF THE INVENTION

1. Field of the Invention

The present invention is directed to an improved method for generating hydrogen and hydrocarbons. More particularly, the present invention is directed to a method of generating hydrogen and hydrocarbons utilizing a superadiabatic reactor, wherein the reactor operates in transient mode and is fed a fuel-rich mixture of reactants.

2. Brief Description of Related Technology

The generation of hydrogen and hydrocarbons from hydrocarbon fuels is an important industrial process. Presently, hydrogen production from hydrocarbon fuels is performed by either one or more of the following industrial processes: thermal decomposition, steam reforming, and partial oxidation. The majority of production units for hydrogen and synthesis gas, which is a mixture containing predominantly hydrogen (H₂) and carbon monoxide (CO), can be described as one, or a combination, of these three processes.

Each of these industrial processes are well-known in the art. For example, a review of these commercial processes can be found in D. Borum, Gas Engineer's Handbook, Vol. 1, Chapter 6, C. G. Segeler, Ed., New York Industrial Press (1965), and in K. E. Cox et al., Hydrogen: Its Technology and Implications, Vol. 1, CRC Press (1997). These current industrial processes can be summarized as follows.

Thermal decomposition involves the decomposition of hydrocarbon fuels by high temperatures. Thermal decomposition also is termed cracking or pyrolysis. The major thermal decomposition reaction is of the type

CₙH₂ₙ₊₂→nC+(n+1)H₂,

wherein n typically is a number ranging from one to about fifty. The above reaction is highly endothermic and, therefore, requires long reaction times at normal process temperatures to effectively complete the decomposition. To overcome this disadvantage, water or oxygen can be added to the feed fuel, thereby achieving a small amount of steam reforming or partial oxidation. The addition of water or oxygen increases the rate of the overall process because of the attainment of higher mean reaction temperatures.

Thermal decomposition is a relatively simple process, and is adaptable to a wide range of fuels. But thermal decomposition requires very high energy densities, and produces large amounts of soot and heavy hydrocarbon by-products. While these by-products often have value, they also create significant problems with respect to separation of decomposition products.

Steam reforming also is a common industrial process. Although some of the reactions occurring in steam reforming involve the presence of oxygen, the overall chemical reactions can, in general, be described by:

CₙH₂ₙ₊₂+nH₂O→nCO+(2n+1)H₂

CₙH₂ₙ₊₂+2nH₂O→nCO+(3n+1)H₂.

Like thermal decomposition, these reactions are highly endothernic. The steam reforming process, therefore, usually is performed with the aid of catalysts and at high temperatures. The use of a catalyst however creates problems, such as increased cost, catalyst poisoning, and heat transfer to the catalytic material. In addition, catalysts usually are fuel specific, and each catalyst has specific or inherent limitations. An additional disadvantage is the cost associated with catalyst disposal. However, steam reforming has the advantages of utilizing inexpensive feed components, and the potential for high yields of hydrogen. The high yield potential results from the fact that hydrogen is derived not only from the hydrocarbon fuel, but also from the water.

Partial oxidation processes are substantially different from the thermal decomposition and steam reforming processes. Partial oxidation relies upon the reaction of a hydrocarbon fuel with a small amount of oxygen, i.e., an oxygen-carbon ratio of about 1 to 1 (O:C=1:1), resulting in H₂ and CO as the major oxidation products. The idealized overall stoichiometry of the combustion is given by:

$${C}_{n} {H}_{2 n + 2} + \frac{n}{2} {O}_{2} \to n CO + ( n + 1 ) {H}_{2} .$$

The specific reaction steps in partial oxidation actually are more complicated than the foregoing idealized reaction. Partial oxidation consists of an initial rapid combustion of the fuel to predominantly water and carbon dioxide until the oxygen is consumed. This reaction is followed by a slower reforming of the initial product mixture to H₂ and CO. Partial oxidation can be performed in either catalytic or high temperature noncatalytic processes.

Similar to the first two processes, partial oxidation requires high operating temperatures. An additional disadvantage of the partial oxidation process is the need for oxygen as a feed component. This disadvantage adds to the cost of the process, either because of a large heat input to attain a desired reactor temperature when using air as the oxygen source, or because of the cost of supplying pure oxygen.

Of the three process described above, however, the partial oxidation process is the only one providing an exothermic reaction. Accordingly, the energy input required in a partial oxidation does not increase proportionally to the throughput. Furthermore, under certain circumstances, the exothermic reaction can occur rapidly, and can be self-sustaining, thereby allowing for a high degree of fuel conversion at a low energy cost.

As discussed in detail hereafter, the principles of partial oxidation are utilized in the present invention because of the advantages of achieving high efficiencies, generating low levels of soot and heavy hydrocarbon by-products, and requiring shorter reaction times relative to other hydrogen generation methods. The present invention, however, provides a process that is an improvement on prior partial oxidations processes, and can be performed without the assistance of a catalyst. To date, relatively few experimental studies of non-catalytic partial oxidations have been published, because most work has focused only on catalytic processes.

One type of partial oxidation, known as superadiabatic combustion (“SAC”), can occur under heterogeneous conditions when a gas-phase fuel/oxidizer mixture having a low caloric heat value (low adiabatic temperature) is flowed through an inert (non-catalytic), solid, porous medium (matrix) having a high thermal capacity. Combustion energy accumulates in the porous medium by an intensive heat exchange between the flowing, burning gas mixture and surfaces of the porous medium. The accumulated energy is used to initiate and sustain the combustion of additional fuel. With such energy accumulation, the flame temperatures that can be achieved are much greater than the adiabatic temperature for the feed fuel mixture, hence, SAC. Generally, superadiabatic or excess enthalpy flame temperatures exist whenever heat is recirculated from hot reaction products to unburned reactants in, for example, self-recuperated burners. Such SAC processes present complex interactions of physical and chemical phenomena in the heterogeneous system, which have not been fully studied or documented.

Prior investigators of SAC generally used a fuel-lean reactant mixture. See, for example, F. J. Weinberg et al., Combust. Flame, 72, pages 235-239 (1988) and H. A. Arbib et al., Eighteenth Symposium (International) on Combustion, The Combustion institute, Pittsburgh, Pa., pages 233-241 (1981), which disclose combustion processes in fluid bed, spouted reactors using reactant mixtures having a maximum equivalence ratio of hydrocarbon to oxygen of about 2 to 1. In contrast, however, the present invention utilizes a superadiabatic process employing a fuel-rich reactant mixture.

### SUMMARY OF THE INVENTION

The present invention is directed to a method for continuously generating combustion products from a fuel-rich reactant mixture. More specifically, the method is directed to a transient superadiabatic combustion (“SAC”), wherein combustion products are continuously generated. The method includes the step of flowing the reactant mixture through a heated zone (e.g., a porous fixed-bed) of a reactor at a speed (u(t)). The reactor contains a porous, fixed-bed (or solid phase), which serves as an intermediate for heat accumulation and regeneration. The reactor operates at a temperature sufficient to result in a SAC of the reactant mixture. The method also includes the step of combusting the reactant mixture in the heated zone to generate the combustion products and heat, the heat being sufficient to maintain the operating temperature of the heated zone for the SAC of additional reactant mixture. The heat preferably is in the form of a transient thermal wave, which moves through the fixed-bed at a speed (v(t)) roughly similar to that of the reactant mixture (u(t)). In this manner the reaction mixture (reactant wave) and thermal wave are coupled together to sustain continuous superadiabatic combustion within a reactor containing suitable means for reversing the direction of flow of the reactant mixture or wave and thermal wave.

Suitable apparatus for carrying out the combustion can include a thermally-insulated reactor containing a porous, fixed-bed, the reactor having an inlet and an outlet. The apparatus can also include an initial means for heating a specific portion of the fixed-bed to a temperature sufficient to sustain a SAC of the reactant mixture and means for reversing a direction of flow of the reactant mixture and the product (the heat generated by combustion) inside the reactor.

The porous, fixed-bed can be non-catalytic. The initial heating means can be an external heater in thermal contact with the reactor to heat a localized region of the fixed-bed to initiate SAC. However, once SAC is initiated, preferably at temperatures of about 800° C. to about 2500° C., no external heater is necessary to propagate the continued conversion of reactants. The combustion can be performed at atmospheric pressure, or above or below atmospheric pressure.

The reactant mixture generally includes oxygen and one or more C₁ to C₅ hydrocarbons, and the combustion products typically include hydrogen carbon dioxide and one or more C₂ to C₅ hydrocarbons. In accordance with an important feature of the present invention, the reactant mixture is fuel rich, generally having an equivalence ratio of hydrocarbon fuel to oxygen of greater than about 1.2 to about 20, and preferably about 2.5 to about 15.

Further advantages of the invention may become apparent to those skilled in the art from a review of the following detailed description of the preferred embodiments, taken in conjunction with the drawings and appended claims. While the invention is susceptible of embodiments in various forms, described hereinafter are specific embodiments of the invention with the understanding that the present disclosure is intended as illustrative, and is not intended to limit the invention to the specific embodiments described herein.

### BRIEF DESCRIPTION OF THE DRAWINGS

FIG. 1 is a schematic diagram of a reciprocal-flow or reverse-flow, reactor capable of superadiabatic combustion; and

FIG. 2 is a schematic diagram of a counter-flow reactor capable of superadiabatic combustion.

FIG. 3 is a schematic diagram showing the movement and coupling of the thermal wave and reactant wave in the fixed-bed portion of a reactor.

### DETAILED DESCRIPTION OF THE PREFERRED EMBODIMENTS

As previously discussed, superadiabatic combustion (hereinafter “SAC”) is a process used to produce hydrogen, hydrocarbons, and other useful compounds, like methanol. SAC also can be used to modify and, thereby, improve the combustion characteristics of hydrocarbon fuels. The present invention is directed to an improved SAC process, specifically a transient SAC process, for generating combustion or decomposition products, such as hydrogen and hydrocarbons from a hydrocarbon fuel-rich reactant mixture. While the following detailed description makes occasional reference to the SAC of methane in air, it should be understood that the present invention is not so limited, and encompasses the SAC of other hydrocarbon fuels disclosed hereafter, either in air or in oxygen.

In the following detailed description, reference is made to a fuel-rich reactant mixture. As used here and hereinafter, the reactant mixture is defined as a mixture of hydrocarbon fuel and air (or oxygen) introduced into the reactor wherein SAC occurs. As used hereinafter, a reactant mixture is considered neither fuel rich nor fuel lean when the equivalence ratio of hydrocarbon fuel to oxygen in the reactant mixture is about 0.5 to about 1.2. A fuel-lean reactant mixture has an equivalence ratio of less than about 0.5. A fuel-rich reactant mixture has an equivalence ratio of greater than about 1.2 (e.g., greater than about 1.2 to about 20).

The present invention is directed to a method for continuously generating combustion products from a fuel-rich reactant mixture. More specifically, the method includes the step of flowing the reactant mixture through a heated zone (e.g., porous fixed-bed) of a reactor at a speed (u(t)). The porous, fixed-bed (or solid phase) serves as an intermediate for heat accumulation and regeneration. The reactor operates at a temperature sufficient to result in a SAC of the reactant mixture. The method also includes the step of combusting the reactant mixture in the heated zone to generate the combustion products and heat, the heat being sufficient to maintain the operating temperature of the heated zone for the SAC of additional reactant mixture. The heat preferably is in the form of a transient thermal wave, which moves through the fixed-bed at a speed (v(t)) roughly similar to that of the reactant mixture. In this manner the reaction mixture and thermal wave are coupled together to sustain continuous superadiabatic combustion within a reactor containing suitable means for reversing the direction of flow of the reactant mixture and thermal wave.

Suitable apparatus for carrying out the combustion can includes a thermally-insulated reactor containing a porous, fixed-bed, the reactor having an inlet and an outlet. The apparatus can also include an initial means for heating a specific portion of the fixed-bed to a temperature sufficient to sustain a SAC of the reactant mixture and means for reversing a direction of flow of the reactant mixture and the product (the heat generated by combustion) inside the reactor.

The porous, fixed-bed can be non-catalytic. The initial heating means can be an external heater in thermal contact with the reactor (or other types of heat sources useful) to heat a localized region of the fixed-bed to initiate SAC. However, once SAC is initiated, temperatures of about 800° C. to about 2500° C. can be maintained, and no external heater is necessary to propagate the continued conversion of reactants. The continued conversion of the reactant mixture is accomplished by the transient thermal wave which moves and is coupled to the flow of reactant mixture through the fixed-bed. The combustion can be performed at atmospheric pressure, or above or below atmospheric pressure.

The reactant mixture generally includes oxygen and one or more C₁ to C₅ hydrocarbons, and the combustion products typically include hydrogen, carbon monoxide, and one or more C₂ to C₅ hydrocarbons. In accordance with an important feature of the present invention, the reactant mixture is fuel rich, generally having an equivalence ratio of hydrocarbon fuel to oxygen of greater than about 1.2 to about 20, and preferably about 2.5 to about 15.

SAC of the reactant mixture can be performed in a porous, fixed-bed reactor. A traveling or transient thermal wave first is established in the porous fixed-bed of the reactor, before the reactant mixture is introduced. Thereafter, a zone of chemical reaction is stabilized in the thermal wave. An intense interphase heat transfer occurs between the solid, porous fixed-bed and the reactant mixture, and provides an efficient mechanism for energy exchange, resulting in very effective self-recuperation of thermal energy. This energy exchange mechanism has the ability to significantly increase the gas temperature above the adiabatic temperature of the reactant mixture.

In contrast to prior investigations, which have focused upon fuel-lean combustion systems, the present method performs the SAC in a chemical reactor operating with fuel-rich reactant mixtures having an equivalence ratio of greater than about 1.2 to about 20, more preferably about 2.5 to about 15, and most preferably about 3 to about 10.

The SAC decomposes the reactant mixture with little, and preferably, no addition of external heat after initiation of the reaction. Using the superadiabatic method allows efficient and economic decomposition of hydrocarbon fuels to generate hydrogen, carbon monoxide, acetylene, and related gases, in particular, gaseous hydrocarbons containing two to five carbons, like ethylene, propylene, and butylene, for example. As previously noted, the hydrocarbon fuel used in the present invention typically comprises a gaseous hydrocarbon, such as a hydrocarbon containing one to five carbon atoms. However, hydrocarbons that are liquids at one atmosphere and about 30° C. also can be used as the fuel as long as the hydrocarbon can be introduced into the reactor as a gas. The oxygen source can be air or pure oxygen.

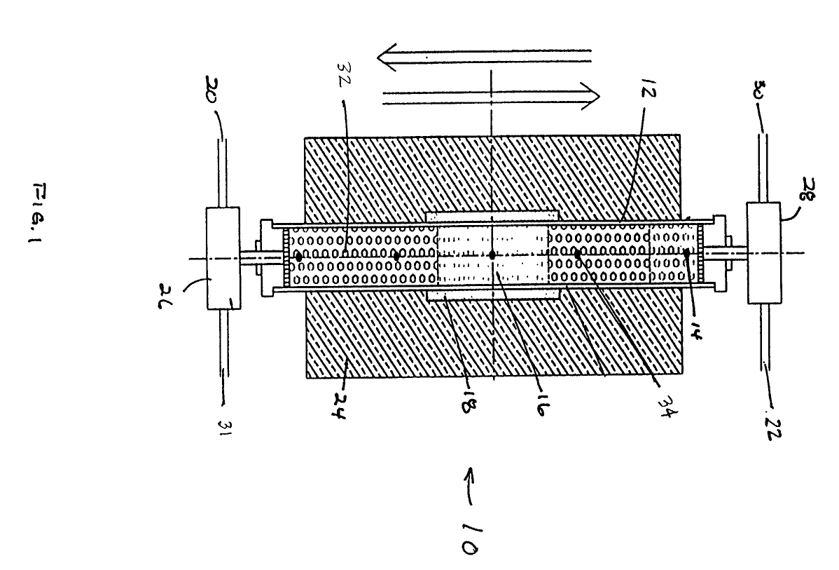

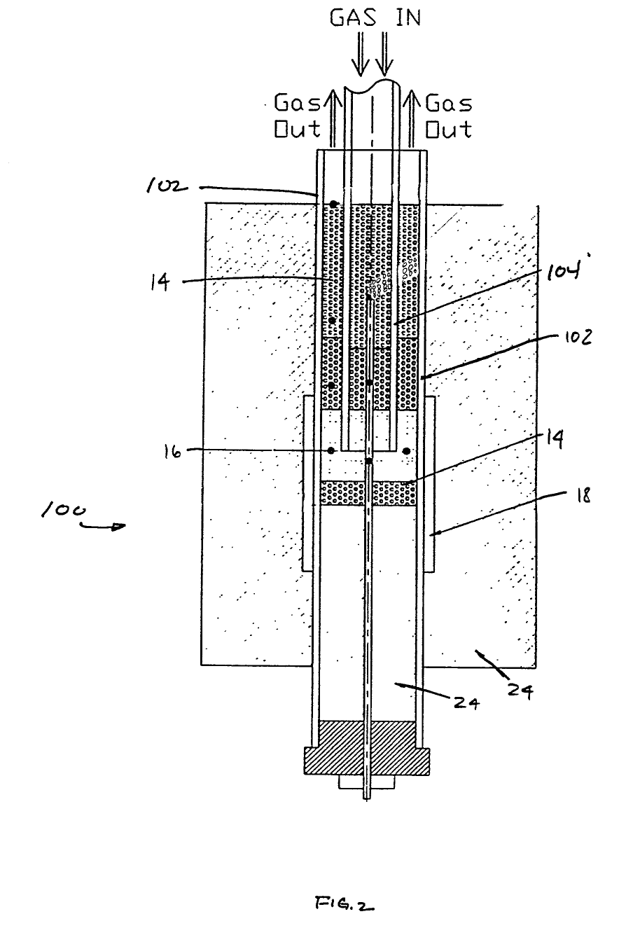

The process of coupling the transient thermal wave (u(t)) to the flow of reactant mixture (v(t)) to obtain SAC can be carried out in a variety of reactors. Examples of such suitable reactors are illustrated in FIGS. 1 and 2, wherein like reference numbers represent identical or similar features in the various views. In each embodiment, and in other embodiments not specifically disclosed herein, the reactor can be configured in an axial or a radial configuration. In addition, the reactors can be operated at atmospheric pressure, or below or above atmospheric pressure. In preferred embodiments, the reactor is pressurized, such that the porous fixed-bed is operated at a pressure greater than 1 atmosphere, and up to about 100 atmospheres. The reactor also can be pressurized to operate at pressures as low as about 0.1 atmosphere.

FIG. 1 illustrates one embodiment of a reactor, generally designated 10, having a reverse-flow configuration, suitable for performing the SAC. This configuration permits the process of coupling the thermal wave and the flow of reactant mixture (reactant wave) to reverse direction when these combined localized waves propagate the length of the reactor. The reverse-flow reactor (“RFR”) 10 includes a tube 12 at least partially, and preferably completely, filled with a porous fixed-bed 14. The tube 12 can be constructed from quartz, ceramic, or a high temperature metal alloy, for example.

The porous fixed-bed 14 can be made up of catalytic material, non-catalytic material, or a mixture thereof. More specifically, the fixed-bed 14 can comprise particles such as, for example, pellets, of alumina, silicon carbide, silicon nitride, quartz, or other similar materials known by those skilled in the art. Preferably, the fixed-bed 14 comprises particles, such as pellets, having a particle size of about 0.05 millimeters (mm) to about 10 mm, preferably about 0.25 mm to about 8 mm, and more preferably about 0.5 mm to about 7 mm in diameter. The porous fixed-bed 14 also can comprise a ceramic material, such as a monolithic ceramic having a honeycomb configuration. Such fixed-beds 14 conventionally are considered noncatalytic, although such fixed-beds 14 may exhibit some catalytic behavior at reaction temperatures specified by the present invention.

The fixed-bed 14 also can be constructed from catalytic materials that are well known in the art of high temperature hydrocarbon decomposition such as, for example, nickel oxide or platinum. A catalyst is not required in the fixed-bed 14, but, in preferred embodiments, the fixed-bed 14 comprises about 0.001% to about 10%, by weight of a catalyst. In addition, the fixed-bed can contain a mixture of materials, or can comprise layered zones of different materials.

To perform a particular reaction that yields desired, and predetermined, reaction products, persons skilled in the art are capable of selecting the proper material comprising the porous fixed-bed 14 by considering identity of the material, particle size, density, shape, and thermal properties to optimize reaction yields. Regardless of the materials comprising the fixed-bed 14, the fixed-bed 14 should have sufficient porosity to permit gas flow therethrough. Typically, a suitable fixed-bed 14 has a porosity of about 10% to about 90%, preferably about 20% to about 80%, and more preferably about 30% to about 70%.

During operation of RFR 10, a target reaction (or SAC) zone 16 in fixed-bed 14 is heated by a heating means 18 before a fuel-rich reactant mixture is introduced into fixed-bed 14 via an inlet 20. The heating means 18 can be, for example, an electric heater. In preferred embodiments, the heating means 18 is disengaged after the SAC of the fuel-rich reactant mixture is initiated. Initiation of the SAC, and subsequent reactions, generate sufficient heat to sustain the SAC of the reactant mixture. As used herein, SAC refers to combustion occurring in a zone of the reactor 10, for example SAC zone 16, having a temperature greater than the adiabatic temperature of the reaction mixture.

Once the heating means 18 has provided a heat input to raise the temperature within the combustion zone 16 to a temperature sufficient to initiate a reaction (i.e., self-ignition combustion temperature), the fuel-rich reactant mixture is flowed into the reactor where a combustion occurs, generating a wave of heat and combustion products. The combustion zone 16 is established and stabilized in reactor 10 as the reactant mixture passes through fixed-bed 14, and reaction products (e.g., hydrogen and/or hydrocarbons and other products) exit reactor 10 through an outlet 22. Thermal insulation 24 prevents undesired heat loss from reactor 10.

Once initiated, the coupled thermal combustion waves will propagate within the reactor 10 infinitely as a self-sustained process. It is not practical, however, to have an unrestricted length. Hence, to restrict propagation of the wave in a given reactor volume, a porous fluid-bed could be moved in a direction opposite to the direction of the propagating wave. This, however, also would be impractical and especially difficult to control. The confinement and control of the wave is achieved more practically by a variable flow-direction control. Hence, after an operating time of about one second to about thirty minutes, preferably about thirty seconds to about 300 seconds, the gas flow of reactant mixture and products through the RFR 10 is reversed by engaging valves 26 and 28 such that the reactant mixture enters the reactor 10 and the fixed-bed 14 through an inlet 30, reacts in SAC zone 16 to form combustion products, the products being discharged from the fixed-bed 14 and the reactor 10 through an outlet 31. The flow of the reactant mixture and the resulting products is reversed. Reversal of the flow of the reactant mixture essentially confines and controls the SAC wave to zone 16 of the apparatus. The rate that the coupled waves (thermal wave and reactant wave or mixture) propagate and the period of flow reversal permits a variable length of the SAC zone 16 in the apparatus by this process.

More specifically, in a first half-cycle, the combustion wave travels upward through zones 32, 16, and 34, in the direction of gas flow. The heat released in the SAC zone 16 is accumulated in the porous fixed-bed adjacent to the SAC, namely zone 34, as the SAC zone 16 moves downstream. To reverse the wave, the direction of reactant mixture gas flow is changed by operation of valves 26 and 28, such that the reactant mixture gas flows downward through zones 34, 16, and 32. In this second half-cycle, the heat which was accumulated in zone 34 is now used to preheat the reactant mixture gas flow entering the reactor 10 and the porous fixed-bed 14 through the feed inlet 30. The combustion wave is effectively stabilized by periodically reversing the direction of the reactant mixture gas flow. The frequency of such a flow reversal permits optimization of the reaction temperature within the reactor 10, and allows the energy stored in the porous fixed-bed zones 32 and 34 to be used to heat the incoming reactant mixture. This highly effective regeneration of energy results in a superadiabatic effect wherein the temperature achieved in the SAC zone 16 can significantly exceed the adiabatic temperature of the incoming reactant mixture gas flow. Furthermore, the ability to recirculate heat to the reactant mixture gas flow without dilution of the product significantly extends the limits of flamability and the stability of the flame.

Tests have shown that for methane/air mixtures having equivalence ratios up to about 6, the reciprocal- or reverse-flow reactor 10 provides self-sustained, SAC of fuel-rich mixtures at combustion zone temperatures of about 1000° C. to about 1700° C. The SAC processes are related to the identity of compounds in the reactant mixture, and the desired products, and, therefore, operate at self-sustained temperatures of about 800° C. to about 2500° C. at an equivalence ratio of greater than about 1.2 to about 20, and preferably about 2.5 to about 15. Based on axial location within the fixedbed 14, there is a trapezoidal temperature distribution characterized by the SAC zone 16 having a high temperature, adjacent to zones 32 and 34 having steep temperature gradients.

Theoretically, a lower time limit of the flow reversal period (or cycle) is determined by the time of gas flow through the length of the reactor 10, whereas the time of thermal wave propagation through the porous fixedbed 14 establishes a maximum flow reversal cycle time. Practically, as the flow reversal cycle time is decreased, the volume of gaseous reactant mixture that has not reached the combustion wave increases. The dilution of the combustion product (exhaust gases) with an increasing percentage of gas lowers the conversion efficiency. In contrast, as the flow reversal cycle time is increased, the combustion wave travels a larger distance in the reactor 10. This results in a trapezoidal temperature distribution with a broad centralized high-temperature plateau and narrow lateral temperature gradients near the ends of the reactor 10, briefly described above. A narrowing of the lateral temperature gradients as the flow reversal period is increased results in a decrease in the heat recuperation efficiency of the reactor 10, due to a decrease in the residence time available for heating incoming reactant mixture before the self-ignition combustion temperature is reached.

FIG. 2 illustrates another example of a reactor, generally designated 100 and having a counter-flow configuration, suitable for carrying out the transient SAC of the present invention. The counterflow reactor (CFR) 100 is defined by a vessel 102 and a tube 104 disposed coaxially within the vessel 102. Both of the vessel 102 and the tube 104 may be constructed of ceramic, quartz, or high temperature metal alloy. The tube 104 is positioned, preferably coaxially, in the vessel 102 to provide an annular space between the vessel 102 and the tube 104, each being filled with a material to provide a porous fixed-bed 14. A first end of the tube 104 is positioned in the vessel 102 to provide a zone 16 for the SAC. The vessel 102 is surrounded by insulating material 24 to reduce or prevent undesirable heat dissipation. A reactant mixture is introduced into CFR 100 through a second end of the tube 104, which is external to the reactor 100. The reactant mixture exits the first end of the tube 104 and enters the zone 16 which has been heated by heating means 18, such as an electric heater, or other energy source, to a temperature sufficient to initiate the SAC.

Once the reaction is initiated, the reaction is self-sustaining as additional reactant mixture is introduced to zone 16 through tube 104. The reaction products exit CFR 100 through the annular space between the vessel 102 and the tube 104. The hot reaction products transfer heat to incoming reactant mixture within the tube 104 as the products exit the CFR 100. In the CFR 100, heat transfer efficiencies of about 40% have been demonstrated.

Similar to the RFR 10, the CFR 100 provides self-sustained SAC for methane/air mixtures having equivalence ratios of up to about 6. The temperature in the SAC zone (i.e., zone 16), was about 1000° C. to about 1700° C., in contrast to the trapezoidal temperature distribution obtained via SAC in the RFR 10. The CFR 100 provides an asymmetric temperature distribution, such that the exhaust temperature of products vessel 102 is high. A high exhaust temperature significantly reduces the possibility of hydrocarbon deposition within the CFR 100.

Tests have shown a high conversion rate of methane to hydrogen in the CFR 100, with low amounts of by-product formation. Tests also have shown that altering process parameters can provide different combustion products. For example, at an equivalence ratio of 2.75, a methane/air feed rate of 0.2 grams per second (g/sec) yielded acetylene, but no detectable ethylene. At the same equivalence ratio and a methane/air feed rate of 0.17 g/sec, ethylene was produced, but acetylene was not detected. Accordingly, process parameters can be varied to yield desired products.

Localization of the high-temperature region (i.e., the SAC zone 16) within the reactor makes it possible to control, reduce, and/or eliminate undesirable heat dissipation. This is accomplished by applying a thick layer of thermal insulation around and/or adjacent to the localized high-temperature region of the reactor. The result is that more heat may be recirculated inside the reactor and ultra-low heat content mixtures (e.g., those having adiabatic temperatures less than 50° C.) can be burned readily in a stable manner. The maximum temperature inside the reactor, and specifically inside the SAC zone, can be as high as twenty times the adiabatic temperature of a given reactant mixture. Such a maximum attainable temperature is significantly higher than that observed for a linear SAC wave propagation.

Based on the trapezoidal temperature profile obtained in a reverse flow reactor as a function of the axial position within the reactor, it is possible to achieve homogeneous gas temperatures of about 2500° C. inside the SAC zone and, concurrently, steady state gas temperatures of about 100° C. near the outlets and inlets of the reactor. Such a temperature profile indicates that the cooling rate is high and is sufficient to effectively quench the reaction. Effective quenching means that it is possible to avoid the influence of an undesirable reverse chemical reaction resulting in particulate formation within the reactor, such as the formation of soot.

The enthalpy input into a propagating linear SAC zone wave causes an increase in the length of the combustion zone. Much of the enthalpy input here is lost due to the inability to localize the combustion zone and the corresponding difficulty in providing adequate insulation to the increasingly growing SAC zone. The inability to insulate results in undesirable radial conductive heat losses. In contrast, however, with a reverse flow superadiabatic combustor 10, radial heat losses are minimized due to the localization of the combustion zone 16 and the effective insulation 24.

In addition, currently known membrane technology can be used in conjunction with the SAC process to separate the product mixture into individual components. Varying the operating pressure of the SAC also can provide an increased yield of a product of interest, while assisting in the separation of the product gas stream into individual components.

In each of the two examples of the apparatus illustrated herein, self-recuperation of heat permits the partial oxidation and pyrolysis of methane at reaction temperatures significantly greater than the adiabatic temperature of the unheated mixture. Additionally, the superadiabatic oxidation and pyrolysis of methane may be conducted in the presence of air to provide a fuel-rich reactant mixture having an equivalence ratio greater than about 1.2 and up to about 20, and preferably about 2.5 to about 15, and most preferably about 3 to about 10. A high degree of methane conversion to hydrogen may be obtained at equivalence ratios of about 2 to about 3. Utilizing high equivalence ratios not only provids good conversion of methane to hydrogen, but also produces significant amounts of ethylene, acetylene, and polyaromatic hydrocarbons. Accordingly, the present SAC process can be utilized to provide a predetermined product stream by the judicious selection of a reactant mixture and process parameters.

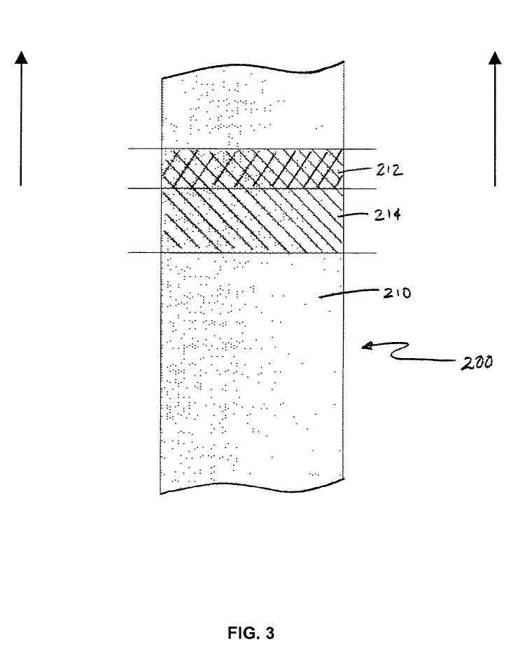

For the sake of clarity, FIG. 3 illustrates a portion (a porous fixed-bed) 210 of a reactor generally designated 200. Shown therein is a reaction wave 212 moving through the porous fixed-bed 210 in the direction of the arrows at a speed of (u(t)), and a thermal wave 214 also moving in the direction of the arrows at a speed of (v(t)). As shown, the reactant wave 212 overlaps with the thermal wave 214. This overlap is an example of “coupling.” Coupling occurs when (u(t)) is roughly the same as (v(t)). More specifically, coupling occurs when the difference between (u(t)) and (v(t)) is less than about 11%, preferably less than about 5%, more preferably less than about 1%, and most preferably when (u(t)) is the same as (v(t)). Transient superadiabatic combustion is carried out when the reactant wave 212 and thermal wave 214 are coupled and propagate together through the reactor 200.

The present method of superadiabatic composition provides advantages over prior hydrocarbon decomposition and combustion methods in the generation hydrogen. For example, the present method provides a simple and efficient approach to generating hydrogen and C₂ to C₅ hydrocarbons from methane, for example, with little or no external energy supply required after initiating the reaction. This feature provides an inherent cost benefit over steady state processes once the SAC is initiated, because there are little to no process energy costs in maintaining the reaction. In contrast, steady state SAC processes require continuous use of external heating means. The method can be carried out in a variety of reactors outfitted with a reverse flow-direction control. The superadiabatic reaction process also can be designed to provide an approximately constant reactor temperature and a controlled quench rate.

In addition, fuel reforming, such as the chemical conversion of feed fuel molecules into different fuel molecules, has the potential of being an important aspect of future energy and power systems. The development of compact, efficient fuel reformers that can be directly integrated into fuel supply systems hold many advantages, such as, for example, devices like fuel cells that can be used with current fuels, and power devices that can be operated with greater flexibility and reduced emissions. The present SAC material can be used in such fuel reforming processes.

The superadiabatic process and apparatus of the present invention also can be used in fuel modification and processing, for example, syngas and hydrogen production, as well as combustion-based synthesis of higher hydrocarbons. For example, the conversion of natural gas to hydrogen and methane, plus other C₂ to C₅ hydrocarbons.

The foregoing description is given for clearness of understanding only, and no unnecessary limitations should be understood therefrom, as modifications within the scope of the invention may be apparent to those skilled in the art.

We claim:

1. A method of continuously generating combustion products from a fuel-rich reactant mixture, the method comprising:
(a) flowing the reactant mixture through a heated zone of a reactor, the reactor containing a porous fixed-bed and operating at a temperature sufficient to result in a superadiabatic combustion of the reactant mixture; and,
(b) combusting the reactant mixture in the heated zone to generate the combustion products and heat, the heat being sufficient to maintain the operating temperature of the heated zone for the superadiabatic combustion of additional reactant mixture.

2. The method of claim 1 wherein the reactant mixture comprises oxygen and one or more C₁ to C₅ hydrocarbons.

3. The method of claim 1 wherein the combustion products comprise hydrogen, carbon dioxide, and one or more C₁ to C₅ hydrocarbons.

4. The method of claim 3 wherein the hydrocarbon comprises ethylene, propylene, butylene, acetylene, or mixtures thereof.

5. The method of claim 1 wherein the operating temperature of the heated zone is about 800° C. to about 2500° C.

6. The method of claim 5 wherein the operating temperature of the heated zone is about 1000° C. to about 1700° C.

7. The method of claim 1 wherein the reactant mixture has an equivalence ratio of hydrocarbon to oxygen of greater than about 1.2 to about 20.

8. The method of claim 1 wherein the equivalence ratio is about 2.5 to about 15.

9. The method of claim 8 wherein the equivalence ratio is about 3 to about 10.

10. The method of claim 1 wherein the reactor is operated at an internal pressure of about 0.1 atmospheres to about 100 atmospheres.

11. The method of claim 10 wherein the reactor is operated at an internal pressure of about 1 atmosphere to about 100 atmospheres.

12. The method of claim 1 wherein the fixed-bed has a porosity sufficient to allow gas flow therethrough.

13. The method of claim 12 wherein the fixed-bed has a porosity of about 10% to about 90%.

14. The method of claim 12 wherein the fixed-bed comprises pellets made from a material selected from the group consisting of alumina, silicon carbide, silicon nitride, and quartz.

15. The method of claim 14 wherein the pellets have a diameter of about 0.05 millimeters (mm) to about 10 mm.

16. The method of claim 12 wherein the porous material comprises about 0.001 weight percent (wt. %) to about 10 wt. % of a catalyst.

17. The method of claim 1 wherein the heat is a transient thermal wave.

18. The method of claim 17 wherein the thermal wave is coupled to the flow of the reactant mixture.
